(19) United States
(12) Patent Application Publication
(10) Pub. No.: US 2024/0309994 A1
(43) Pub. Date: Sep. 19, 2024

(54) BOSS ASSEMBLY FOR A PRESSURE VESSEL

(71) Applicant: PLASTIC OMNIUM NEW ENERGIES FRANCE, Lyon (FR)

(72) Inventors: Bjorn CRIEL, Bruxelles (BE); Geert NOUWEN, Bruxelles (BE); Dries DEVISSCHER, Bruxelles (BE); Khanh-Hung NGUYEN, Bruxelles (BE)

(73) Assignee: PLASTIC OMNIUM NEW ENERGIES FRANCE, Lyon (FR)

(21) Appl. No.: 18/578,426

(22) PCT Filed: Jul. 15, 2022
(86) PCT No.: PCT/EP2022/069872

§ 371 Date: Jan. 11, 2024

(30) Foreign Application Priority Data
Jul. 16, 2021 (LU) 102845

(51) Int. Cl. F17C 1/04

(52) U.S. Cl. CPC F17C 1/04; F17C 2201/0109; F17C 2203/0604; F17C 2203/066; F17C 2203/0663; F17C 2203/0673; F17C 2205/0305; F17C 2209/2163; F17C 2223/0123; F17C 2270/0168

(57) ABSTRACT

A boss assembly may be configured for a pressure vessel having a liner defining a fluid storage chamber and a composite shell enclosing or encasing the liner. Such a boss assembly may include a dome reinforcement part made of fiber-reinforced composite material coupled to a boss part. The dome reinforcement part may be configured to be covered by the composite shell and configured to cover a dome portion of the liner. The boss part may be mechanically coupled to the dome reinforcement part during the dome reinforcement part fabrication.

### TECHNICAL FIELD OF THE INVENTION

The present invention relates to a boss assembly for a pressure vessel having a liner defining a fluid storage chamber and a composite shell enclosing or encasing the liner. The fluid is either a compressed gas such as compressed dihydrogen gas (CGH₂), compressed natural gas (CNG), a liquefied gas such as liquefied petroleum gas (LPG), liquefied natural gas (LNG) or other various pressurized substances.

The invention also relates to a pressure vessel comprising various components including the boss assembly according to the invention. The invention further relates to a method of manufacturing a boss assembly according to the invention. The invention further relates to a method of manufacturing a pressure vessel according to the invention. The invention further relates also to a vehicle comprising a pressure vessel according to the invention.

### BACKGROUND OF THE INVENTION

A typical pressure vessel for storing a fluid at high pressure comprises a liner defining a fluid storage chamber. The liner generally comprises a substantially cylindrical central portion extending along a longitudinal axis on the two sides of which dome-shaped caps (as known as “domes”) are provided for closing the fluid storage chamber. At least one polar opening equipped with a polar boss is provided for charging and discharging a fluid into and out of the fluid storage chamber.

To stiffen the liner and make it resistant to the high pressure inside the fluid storage chamber when the pressure vessel is filled with a pressurized substance, the liner is enclosed or encased in a composite shell.

It is known to obtain a composite shell by using filament-winding method. The filament-winding method is a method in which reinforcement fiber bundles (yarns) are impregnated with resin beforehand to prepare a tow shaped prepreg and the composite shell is formed by winding the tow shaped prepreg on the liner, or a method in which fiber bundles, which are fed in a predetermined direction, are impregnated with resin to be wound onto a liner.

In a pressure vessel equipped with a composite shell fabricated by filament-winding, an important amount of reinforcement fibers is used. Indeed, the composite shell comprises both circumferential layers (also known as “hoop layers”) and helical layers to provide pressure strength in both radial and axial directions. The fibers in the circumferential layers have a tangential fiber direction to provide pressure strength in circumferential direction in the cylindrical central portion of the pressure vessel. The helical layers provide axial pressure strength of the pressure vessel in its central portion but also cover the domes for withstanding internal pressure in this region.

Winding the fibers by means of helical layers for reinforcing the domes of the pressure vessel requires more fiber material than would be necessary for reinforcing the cylindrical central portion axially. However, a continuous winding process involves placing the helical layers continuously over the domes and over the central portion, whereby a lot of fiber material has to be used in the central portion, which increases the weight, production time and cost of the pressure vessel.

The international patent application WO2017137278A discloses a pole cap reinforcement layer that allows using less fiber material for fabricating the composite shell while maintaining the same strength properties. However, this solution implies the polar boss to be mounted on the liner prior to applying the pole cap reinforcement layer onto the dome, which is not satisfactory because it increases the number of assembly clearances and the number of assembly operations, which complicates the production of the pressure vessel.

There is therefore a need for a pressure vessel, and a corresponding method of manufacturing the same, which can be effectively reinforced in the dome region both cost-effectively and time-efficiently using as small an amount of fiber material as possible, while avoiding increase in assembly clearances and assembly operations.

### SUMMARY OF THE INVENTION

The present invention provides a boss assembly for a pressure vessel having a liner defining a fluid storage chamber and a composite shell enclosing or encasing the liner, the boss assembly comprises a dome reinforcement part made of fiber-reinforced composite material coupled to a boss part, the dome reinforcement part being configured to be covered by the composite shell and configured to cover a dome portion of the liner, wherein the dome reinforcement part is mechanically coupled to the boss part during the dome reinforcement part fabrication and wherein the dome reinforcement part is fixedly coupled to the boss part by means of securing means which comprises an axial abutment portion arranged on the boss part for blocking axial movement of the dome reinforcement part relative to the boss part.

Compared with prior art, the boss assembly according to the invention is fabricated without any assembly clearance between the boss part and the dome reinforcement part. This provision allows reducing the total number of assembly clearances and assembly operations required for manufacturing a pressure vessel. Moreover, the fact that the dome reinforcement part is mechanically coupled to the boss part during the dome reinforcement part fabrication means that the boss assembly according to the invention is a stand-alone boss assembly, which allows the boss assembly to be mounted on the liner in one single step compared with prior art where the polar boss part and the pole cap reinforcement layer are two separate parts mounted one after the other on the liner. The securing means allows the dome reinforcement part to be secured to the boss part so that the boss assembly can be handled as a single unit, reducing production time.

In a preferred embodiment, the liner is a plastic liner made of thermoplastic material. This allows manufacturing type IV pressure vessel.

In a preferred embodiment, the composite shell is a fiber-reinforced composite shell. This allows for a good compromise between weight reduction and mechanical strength of the fiber-reinforced composite shell.

The boss part is either a polar boss or a blind boss. A boss part is a fitting attached to the liner and is configured to provide a connection to a valve system in case of a polar boss, or to hold the liner in a filament-winding machine in case of a blind boss.

In a preferred embodiment, the boss part is made of a material selected from the group consisting of metal, plastic and ceramic. Preferably, the boss part is made of aluminum. This allows for a good compromise between weight reduction and mechanical strength of the boss part.

In a preferred embodiment, the composite material of the fiber-reinforced composite material is selected from the group consisting of thermoset resin and thermoplastic polymer. Preferably, the composite material of the fiber-reinforced composite material is a thermoset resin.

A thermoset resin is formed by mixing two or more reactive components forming a reactive thermoset precursor, which reacts upon exposure to curing conditions (e.g. heat, UV or other radiations, or simply by contacting them with one another, etc.) to form the thermoset resin. The thermoset matrix must be fully cured to yield high performance composites. Once cured, the thermoset resin is solid and cannot be further processed or reshaped as the resin is unable to flow anymore. Examples of thermoset resins include unsaturated polyester, epoxy, vinyl ester, polyurea, isocyanurate, and polyurethane resins. It is possible to produce thermoset prepregs made of fibers impregnated with a reactive resin which has been only partially cured to make it tacky, but still soft. The prepregs can be stored and later further processed under pressure by heating or exposing the resin to UV to complete curing and consolidating the prepregs.

A thermoplastic polymer can pass from solid state (or non-flowable state) to a liquid state (or flowable state) and reverse by increasing and lowering the temperature, respectively. In case of semi-crystalline polymers, lowering the temperature of the thermoplastic drives the formation of crystals and the solidification of the thermoplastic. Inversely, heating a semi-crystalline polymer above the melting temperature thereof melts the crystals and the thermoplastic can flow. Examples of semi-crystalline thermoplastics include polyether ketones such as PEEK, PEKK, PEKKEK, polyamides, such as PA6, PA66, PA10, PA11, PA12, polyolefins such as PE, PP, and the like. Amorphous thermoplastics do not form crystals and do not have a melting temperature. The amorphous thermoplastics solidify or become flowable depending on whether the material temperature is below or above the glass transition temperature thereof. Examples of amorphous thermoplastics include PEI, PSU, PES, PC, PS, TPU, and the like. Both semi-crystalline and amorphous thermoplastics can therefore be reshaped by heating them above their melting or glass transition temperatures and frozen into their new shape by lowering the temperature accordingly. Even though not strictly correct from a physical point of view, for sake of simplicity, both semi-crystalline and amorphous thermoplastics in a liquid state are herein referred to as a “thermoplastic melt”.

In a preferred embodiment, the fibers of the fiber-reinforced composite material are fibers selected from the group consisting of carbon fibers, aramid fibers and glass fibers. This allows for a good compromise between weight reduction and mechanical strength of the fiber-reinforced composite material.

In a preferred embodiment, the fibers of the fiber-reinforced composite material used for fabricating the dome reinforcement part are continuous fibers with high modulus. This further improves the mechanical strength of the fiber-reinforced composite material.

In a preferred embodiment, the dome reinforcement part is fabricated using at least one of the techniques selected from the group consisting of winding, wrapping, braiding and tape placement techniques, and the boss part is used as a part of a mandrel for fabricating the dome reinforcement part. Advantageously, the tape placement technique is a laser assisted tape placement (LATP) technique.

Preferably, the dome reinforcement part is fabricated using a winding technique and the boss part is used as a winding part of a mandrel for fabricating the dome reinforcement part.

In a preferred embodiment, the boss part is a polar boss comprising a neck part including an axial cylindrical hollow portion providing a fluid communication port, one axial end of the neck part being configured to provide a first coupling surface for coupling the boss part to the liner. Preferably, the first coupling surface is a first contact surface between the boss part and the liner.

In another preferred embodiment, the polar boss further comprising a flange part extending radially outwardly from the neck part, the flange part having an inner surface and an outer surface, the inner surface of the flange part being configured to provide a second coupling surface for coupling the boss part to the liner, and the outer surface of the flange part providing a third coupling surface for coupling the dome reinforcement part to the boss part during the dome reinforcement part fabrication. Preferably, the second coupling surface is a second contact surface between the boss part and the liner and the third coupling surface is a third contact surface between the dome reinforcement part and the boss part during the dome reinforcement part fabrication.

In an alternative embodiment, the boss part is a blind boss comprising a neck part.

In a preferred embodiment, the dome reinforcement part is fixedly coupled to the boss part by means of securing means which comprises an adhesive element, e.g. glue, for the adhesion between the dome reinforcement part and the boss part. This allows the dome reinforcement part to be secured to the boss part so that the boss assembly can be handled as a single unit, reducing production time. The use of an adhesive element allows to use a standard boss part for the boss assembly. The adhesive element may be a heat activated adhesive.

In a preferred embodiment, the securing means comprises at least one screw or pin fixed to the outer surface of the flange part. The at least one screw or pin penetrates the dome reinforcement part for blocking radial, axial and rotational movements of the dome reinforcement part relative to the boss part. It is understood that the radial, axial and rotational movements of the dome reinforcement part are defined with regard to the axis of the neck part of the boss part.

In another preferred embodiment, the securing means comprises a radial and rotational abutment portion in the form of a cylindrical surface portion of non-circular cross-sectional shape arranged on an outer surface of the neck part of the boss part. The cylindrical surface portion of non-circular cross-sectional shape is enclosed or encased by the dome reinforcement part for blocking radial and rotational movements of the dome reinforcement part relative to the boss part. The axial abutment portion of the securing means is arranged on the neck part of the boss part for blocking axial movement of the dome reinforcement part relative to the boss part. The cross-sectional shape is disposed in a plane orthogonal to the axis of the neck part of the boss part.

In a preferred embodiment, the non-circular cross-sectional shape is selected from the group consisting of polygonal, elliptical and truncated-circular cross-sectional shape, and wherein the axial abutment portion is selected from the group consisting of at least one of groove, winglet, pin and the like.

The present invention also concerns a pressure vessel comprising a liner defining a fluid storage chamber, a composite shell enclosing or encasing the liner and a boss assembly according to the invention, wherein the dome reinforcement part is covered by the composite shell and covers a dome portion of the liner. A dome portion of the liner is either the entire surface of the dome portion or a portion thereof.

The invention further concerns a vehicle comprising a pressure vessel according to the invention.

The invention further concerns a method of manufacturing a boss assembly, the boss assembly having a dome reinforcement part and a boss part.

The method comprises the steps of:
providing a mandrel having a dome-shaped portion,
positioning the boss part on the dome-shaped portion of the mandrel,
placing the mandrel comprising the boss part in a filament-winding machine,
fabricating the dome reinforcement part by winding layers of reinforcing fibers on the dome-shaped portion of the mandrel and the boss part and fixedly coupling the dome reinforcement part to the boss part by means of securing means which comprises an axial abutment portion arranged on the boss part for blocking axial movement of the dome reinforcement part relative to the boss part so as to mechanically couple the dome reinforcement part to the boss part.

In a preferred embodiment, the step of fabricating the dome reinforcement part by winding layers of reinforcing fibers on the mandrel and the boss part includes a step of winding reinforcing fibers on a fixedly coupling portion of the boss part so as to fixedly couple the dome reinforcement part to the boss part. The fixedly coupling portion is selected from the group consisting of at least one of screw, pin, winglet, groove and cylindrical surface portion of non-circular cross-sectional shape. Alternatively, the step of fabricating the dome reinforcement part by winding layers of reinforcing fibers on the mandrel and the boss part includes a step of applying an adhesive element, e.g. glue, onto the boss part before fabricating the dome reinforcement part. The adhesive element may be a heat activated adhesive.

In a preferred embodiment, the reinforcing fibers are impregnated with a liquid matrix. The method comprises the further steps of:
curing or polymerizing the liquid matrix,
removing the boss assembly from the mandrel,
   thus obtaining a stand-alone boss assembly comprising fiber-reinforced composite material.

The liquid matrix is selected from the group consisting of a reactive thermoset precursor and a thermoplastic melt.

Advantageously, the step of curing or polymerizing the liquid matrix is a step of fully curing or fully polymerizing the liquid matrix. This prevents the dome reinforcement part from chemically reacting (e.g. bonding) with the composite shell when the composite shell is cured or polymerized. In addition, this makes it easy to cut the dome reinforcement part in a further step.

In an alternative embodiment, the reinforcing fibers are dry reinforcing fibers. The method comprises the further steps of:
placing the mandrel comprising the dome reinforcement part and the boss part in a mold,
performing a resin infusion or resin transfer molding process,
removing the mandrel comprising the dome reinforcement part and the boss part from the mold,
removing the boss assembly from the mandrel,
   thus obtaining a stand-alone boss assembly comprising fiber-reinforced composite material.

In a preferred embodiment, the step of removing the boss assembly from the mandrel includes a step of circumferentially cutting the dome reinforcement part. This allows freeing the dome reinforcement part from the mandrel. Moreover, the fact that the dome reinforcement part is fixedly coupled to the boss part allows a more stable cutting operation since the boss part provides a solid gripping of the boss assembly.

In an alternative embodiment, the invention concerns a method of manufacturing a pair of boss assemblies for a pressure vessel, each boss assembly of the pair having a dome reinforcement part and a boss part, comprises the steps of:
providing a mandrel having two symmetrical dome-shaped portions,
positioning each boss part of the pair of boss assemblies on each dome-shaped portion of the mandrel,
placing the mandrel comprising the pair of boss parts in a filament-winding machine,
fabricating each dome reinforcement part of the pair of boss assemblies by winding layers of reinforcing fibers on each symmetrical dome-shaped portion of the mandrel and each boss part of the pair of boss assemblies and fixedly coupling each dome reinforcement part to each boss part by means of securing means which comprises an axial abutment portion arranged on each boss part for blocking axial movement of the dome reinforcement parts relative to the boss parts so as to mechanically couple the pair of dome reinforcement parts to the pair of boss parts. This allows fabricating two boss assemblies at the same time.

In a preferred embodiment, the step of fabricating each dome reinforcement part of the pair of boss assemblies by winding layers of reinforcing fibers on each symmetrical dome-shaped portion of the mandrel and each boss part of the pair of boss assemblies includes a step of winding reinforcing fibers on a fixedly coupling portion of each boss part so as to fixedly couple the pair of dome reinforcement parts to the pair of boss parts. The fixedly coupling portion is selected from the group consisting of at least one of screw, pin, winglet, groove and cylindrical surface portion of non-circular cross-sectional shape. Alternatively, the step of fabricating each dome reinforcement part of the pair of boss assemblies by winding layers of reinforcing fibers on each symmetrical dome-shaped portion of the mandrel and each boss part of the pair of boss assemblies includes a step of applying an adhesive element, e.g. glue, onto the boss parts before fabricating the dome reinforcement parts. The adhesive element may be a heat activated adhesive.

In a preferred embodiment, the reinforcing fibers are impregnated with a liquid matrix, the method comprises the further steps of:
curing or polymerizing the liquid matrix,
removing the pair of boss assemblies from the mandrel,
   thus obtaining two stand-alone boss assemblies comprising fiber-reinforced composite material.

The liquid matrix is selected from the group consisting of a reactive thermoset precursor and a thermoplastic melt.

Advantageously, the step of curing or polymerizing the liquid matrix is a step of fully curing or fully polymerizing the liquid matrix. This prevents the two dome reinforcement parts from chemically reacting (e.g. bonding) with the composite shell when the composite shell is cured or polymerized. In addition, this makes it easy to cut the two dome reinforcement parts in a further step.

In an alternative embodiment, the reinforcing fibers are dry reinforcing fibers, the method comprises the further steps of:
placing the mandrel comprising the pair of dome reinforcement parts and the pair of boss parts in a mold,
performing a resin infusion or resin transfer molding process,
removing the mandrel comprising the pair of dome reinforcement parts and the pair of boss parts from the mold,
removing the pair of boss assemblies from the mandrel,
   thus obtaining two stand-alone boss assemblies comprising fiber-reinforced composite material.

In a preferred embodiment, the step of removing the pair of boss assemblies from the mandrel includes a step of circumferentially cutting the pair dome reinforcement parts. This allows freeing the pair of dome reinforcement parts from the mandrel and splitting it into two separate dome reinforcement parts. Moreover, the fact that each dome reinforcement part is fixedly coupled to a boss part allows a more stable cutting operation since a boss part provides a solid gripping of a boss assembly.

The present invention further concerns a method of manufacturing a pressure vessel comprising a boss assembly, the boss assembly having a dome reinforcement part fixedly coupled to a boss part, the method comprises the steps of:
positioning the boss assembly onto a dome portion of a liner,
fabricating a composite shell over the boss assembly and the liner.

In a preferred embodiment, the step of fabricating the composite shell over the boss assembly and the liner includes a step of curing or polymerizing the composite shell.

In a further preferred embodiment, the step of fabricating the composite shell over the boss assembly and the liner is preceded by a step of injecting a processing gas within the liner. The processing gas is injected at a pressure high enough to eliminate any dimensional clearance that may appear between the liner and the dome reinforcement part due to dimensional variations occurring in the dimensions of the liner and the dome reinforcement part during their fabrication.

It is provided a mandrel for a filament-winding machine having means to accommodate a boss part of a boss assembly according to the invention.

In a preferred embodiment, the means to accommodate a boss part of a boss assembly comprises fastening means for fastening the boss part to the mandrel. Preferably, the fastening means is selected from the group consisting of at least one of screwing means, mechanical interlocking means, quick connect means and the like.

In another preferred embodiment, the mandrel comprises a thermal conditioning system to increase the dimensional stability of the dome reinforcement part shape during the dome reinforcement part fabrication, thus further avoiding increase in assembly clearances. A thermal conditioning system is a system that regulates the temperature of the mandrel within a small temperature range.

### BRIEF DESCRIPTION OF THE DRAWINGS

FIG. 1 is a partial cross-section view of a first embodiment of the invention;

FIG. 2 is a partial cross-section view of a second embodiment of the invention;

FIG. 3 is a partial cross-section view of a third embodiment of the invention;

FIG. 4 is a partial cross-section view of a forth embodiment of the invention;

FIG. 5 is a partial cross-section view of a fifth embodiment of the invention;

FIG. 6 is a partial cross-section view of a sixth embodiment of the invention;

FIG. 7 is a partial cross-section view of a seventh embodiment of the invention;

FIG. 8 is a partial cross-section view of an eighth embodiment of the invention;

FIG. 9 illustrates three examples of non-circular cross-sectional shape;

FIG. 10 illustrates a particular arrangement of the sixth and seventh embodiment.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

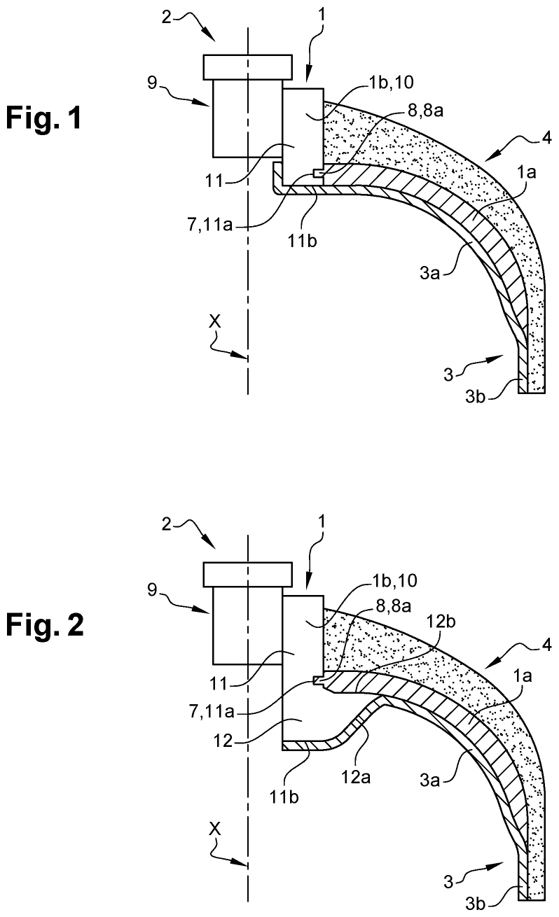

As illustrated in FIG. 1, the present invention concerns a boss assembly 1 for a pressure vessel 2 having a liner 3 defining a fluid storage chamber and a composite shell 4 enclosing or encasing the liner 3. The pressure vessel 2 has a longitudinal axis X and may contain dihydrogen for powering a fuel cell of a vehicle. By the expression “pressure vessel”, is meant a vessel intended for storing gas under pressure able to withstand an internal pressure going up to 700 bar. For example, the pressure vessel may be compliant with Addendum 133-Regulation No. 134 of the “Agreement Concerning the Adoption of Uniform Technical Prescriptions for Wheeled Vehicles, Equipment and Parts which can be Fitted and/or be Used on Wheeled Vehicles and the Conditions for Reciprocal Recognition of Approvals Granted on the Basis of these Prescriptions” issued by the United Nations.

The boss assembly 1 comprises a dome reinforcement part 1a coupled to a boss part 1b. The boss part 1b is made of a material selected from the group consisting of metal, plastic and ceramic. In an example, the boss part is made of aluminum. The dome reinforcement part 1a is made of fiber-reinforced composite material. The composite material of the fiber-reinforced composite material is selected from the group consisting of thermoset resin and thermoplastic polymer and the fibers of the fiber-reinforced composite material are fibers selected from the group consisting of carbon fibers, aramid fibers and glass fibers. Preferably, the composite material of the fiber-reinforced composite material is a thermoset resin and the fibers of the fiber-reinforced composite material are continuous fibers with high modulus. The dome reinforcement part 1a is configured to be covered by the composite shell 4 and configured to cover a dome portion 3a of the liner 3. The dome reinforcement part 1a is mechanically coupled to the boss part 1b during the dome reinforcement part fabrication. In the example, the boss part 1b is connected to a valve system 9.

The dome reinforcement part 1a is fabricated using at least one of the techniques selected from the group consisting of winding, wrapping, braiding and tape placement techniques, and the boss part 1b is used as a part of a mandrel (not shown) for fabricating the dome reinforcement part 1a. Advantageously, the tape placement technique is a laser assisted tape placement (LATP) technique.

Preferably, the dome reinforcement part 1a is fabricated using a winding technique and the boss part 1b is used as a winding part of a mandrel for fabricating the dome reinforcement part 1a.

In the example illustrated in FIG. 1, the boss part 1b is a polar boss 10 comprising a neck part 11 including an axial cylindrical hollow portion providing a fluid communication port. One axial end 11b of the neck part 11 is configured to provide a first coupling surface for coupling the boss part 1b to the liner 3.

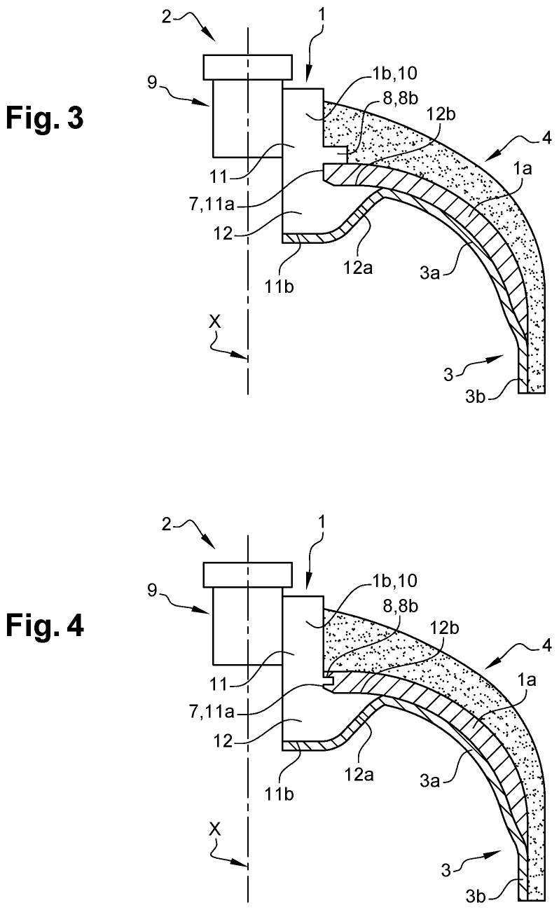

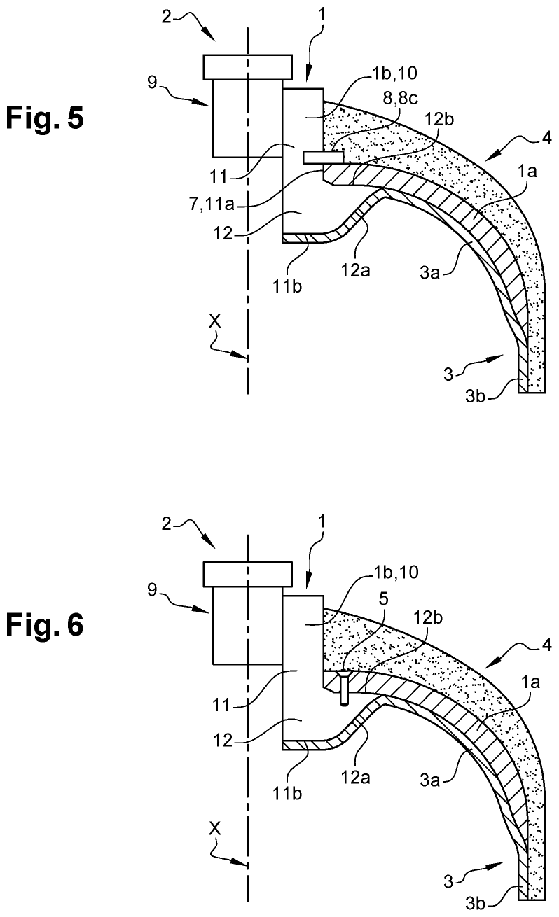

In the examples illustrated in FIGS. 2 to 7, the polar boss 10 further comprises a flange part 12 extending radially outwardly from the axial end 11b of the neck part 11. The flange part 12 has an inner surface 12a and an outer surface 12b, the inner surface 12a of the flange part 12 is configured to provide a second coupling surface for coupling the boss part 1b to the liner 3, and the outer surface 12b of the flange part 12 provides a third coupling surface for coupling the dome reinforcement part 1a to the boss part 1b during the dome reinforcement part fabrication.

In another example (not shown), the boss part 1b is a blind boss comprising a neck part.

Advantageously, the dome reinforcement part 1a is fixedly coupled to the boss part 1b by means of securing means.

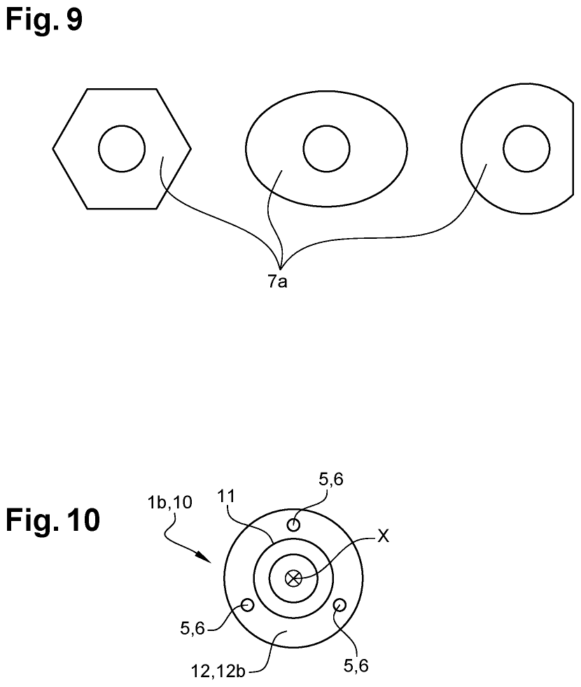

In the embodiments illustrated in FIGS. 1 to 5, the securing means comprises a cylindrical surface portion 7 of non-circular cross-sectional shape 7a (see FIG. 9) arranged on an outer surface 11a of the neck part 11 of the boss part 1b. The cylindrical surface portion 7 of non-circular cross-sectional shape 7a is enclosed or encased by the dome reinforcement part 1a for blocking radial and rotational movements of the dome reinforcement part 1a relative to the boss part 1b. The securing means further comprises an axial abutment portion 8 arranged on the neck part 11 of the boss part 1b for blocking axial movement of the dome reinforcement part 1a relative to the boss part 1b.

As illustrated in FIGS. 1 to 5, the axial abutment portion 8 is selected from the group consisting of at least one of groove 8a, winglet 8b, pin 8c and the like.

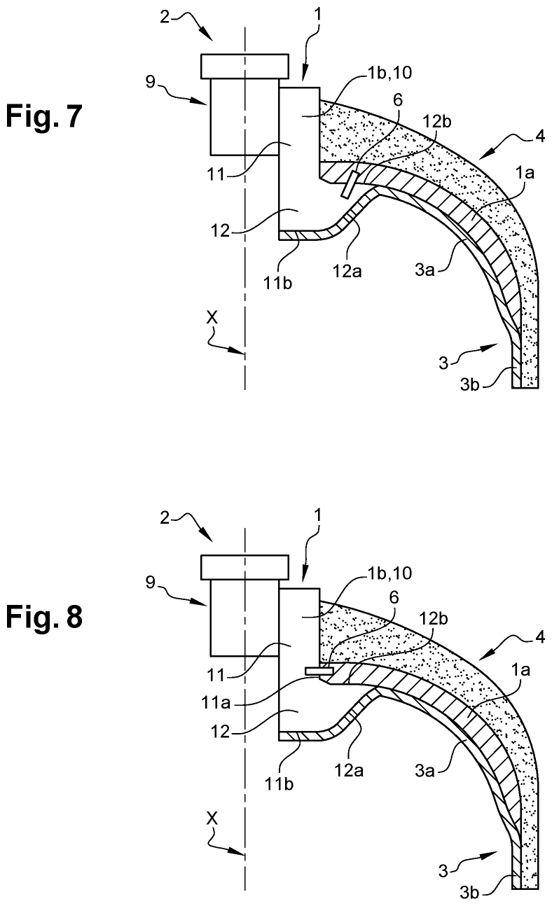

In the embodiments illustrated in FIGS. 6 and 7, the securing means comprises at least one screw 5 or pin 6 fixed to the outer surface 12b of the flange part 12. The at least one screw 5 or pin 6 penetrates the dome reinforcement part 1a for blocking radial, axial and rotational movements of the dome reinforcement part 1a relative to the boss part 1b. In case of screw 5, the axial blocking is ensured by the fact that the screw 5 has a screw head retaining the dome reinforcement part 1a. In case of pin 6, the axial blocking is ensured by the fact that the pin 6 has a pin axis which is secant with the longitudinal axis X preventing any movement of the dome reinforcement part 1a along the longitudinal axis X. In the embodiments illustrated in FIG. 8, the securing means comprises at least one pin 6 fixed to the outer surface 11a of the neck part 11. The at least one pin 6 penetrates the dome reinforcement part 1a for blocking radial, axial and rotational movements of the dome reinforcement part 1a relative to the boss part 1b.

As illustrated in FIGS. 1 to 8, the present invention also concerns a pressure vessel 2. The pressure vessel 2 comprises a liner 3 defining a fluid storage chamber, a composite shell 4 enclosing or encasing the liner 3 and the boss assembly 1. The liner has a dome portion 3a and a cylindrical portion 3b extending along the longitudinal axis X. The dome reinforcement part 1a covers the dome portion 3a of the liner 3, whereas the composite shell 4 covers the dome reinforcement part 1a and the cylindrical portion 3b of the liner 3. In the example, the pressure vessel is a type IV pressure vessel and the liner is a plastic liner made of thermoplastic material.

The present invention further concerns a method of manufacturing a boss assembly 1 for a pressure vessel 2. The boss assembly 1 has a dome reinforcement part 1a and a boss part 1b. The method comprises the steps of:
providing a mandrel having a dome-shaped portion (not shown),
positioning the boss part 1b on the dome-shaped portion of the mandrel,
placing the mandrel comprising the boss part 1b in a filament-winding machine,
fabricating the dome reinforcement part 1a by winding layers of reinforcing fibers on the dome-shaped portion of the mandrel and the boss part 1b so as to mechanically couple the dome reinforcement part 1a to the boss part 1b.

In a preferred embodiment, the step of fabricating the dome reinforcement part 1a by winding layers of reinforcing fibers on the mandrel and the boss part 1b includes a step of winding reinforcing fibers on a fixedly coupling portion of the boss part 1b so as to fixedly couple the dome reinforcement part 1a to the boss part 1b.

In an example, the reinforcing fibers are impregnated with a liquid matrix and the method comprises the further steps of:
curing or polymerizing the liquid matrix,
removing the boss assembly 1 from the mandrel.

Advantageously, the step of curing or polymerizing the liquid matrix is a step of fully curing or fully polymerizing the liquid matrix.

In an alternative example, the reinforcing fibers are dry reinforcing fibers and the method comprises the further steps of:
placing the mandrel comprising the dome reinforcement part 1a and the boss part 1b in a mold,
performing a resin infusion or resin transfer molding process,
removing the mandrel comprising the dome reinforcement part 1a and the boss part 1b from the mold,
removing the boss assembly 1 from the mandrel.

Advantageously, the step of removing the boss assembly 1 from the mandrel includes a step of circumferentially cutting the dome reinforcement part 1a.

In an alternative embodiment, the invention concerns a method of manufacturing a pair of boss assemblies 1 for a pressure vessel 2, each boss assembly 1 of the pair having a dome reinforcement part 1a and a boss part 1b, comprises the steps of:
providing a mandrel having two symmetrical dome-shaped portions,
positioning each boss part 1b of the pair of boss assemblies 1 on each dome-shaped portion of the mandrel,
placing the mandrel comprising the pair of boss parts 1b in a filament-winding machine,
fabricating each dome reinforcement part 1a of the pair of boss assemblies 1 by winding layers of reinforcing fibers on each symmetrical dome-shaped portion of the mandrel and each boss part 1b of the pair of boss assemblies 1 so as to mechanically couple the pair of dome reinforcement parts 1a to the pair of boss parts 1b.

In a preferred embodiment, the step of fabricating each dome reinforcement part 1a of the pair of boss assemblies 1 by winding layers of reinforcing fibers on each symmetrical dome-shaped portion of the mandrel and each boss part 1b of the pair of boss assemblies 1 includes a step of winding reinforcing fibers on a fixedly coupling portion of each boss part 1b so as to fixedly couple the pair of dome reinforcement parts 1a to the pair of boss parts 1b. The fixedly coupling portion is selected from the group consisting of at least one of screw 5, pin 6, 8c, winglet 8b, groove 8a and cylindrical surface portion 7 of non-circular cross-sectional shape 7a.

In a preferred embodiment, the reinforcing fibers are impregnated with a liquid matrix, the method comprises the further steps of:
curing or polymerizing the liquid matrix,
removing the pair of boss assemblies 1 from the mandrel.

The liquid matrix is selected from the group consisting of a reactive thermoset precursor and a thermoplastic melt.

Advantageously, the step of curing or polymerizing the liquid matrix is a step of fully curing or fully polymerizing the liquid matrix.

In an alternative embodiment, the reinforcing fibers are dry reinforcing fibers, the method comprises the further steps of:
placing the mandrel comprising the pair of dome reinforcement parts 1a and the pair of boss parts 1b in a mold,
performing a resin infusion or resin transfer molding process,
removing the mandrel comprising the pair of dome reinforcement parts 1a and the pair of boss parts 1b from the mold,
removing the pair of boss assemblies (1) from the mandrel.

In a preferred embodiment, the step of removing the pair of boss assemblies 1 from the mandrel includes a step of circumferentially cutting the pair dome reinforcement parts 1a into two separate parts.

The present invention further concerns a method of manufacturing a pressure vessel 2 comprising a boss assembly 1. The boss assembly 1 has a dome reinforcement part 1a fixedly coupled to a boss part 1b. The method comprises the steps of:
positioning the boss assembly 1 onto a dome portion 3a of a liner 3,
fabricating a composite shell 4 over the boss assembly 1 and the liner 3.

In a further preferred embodiment, the step of fabricating the composite shell 4 over the boss assembly 1 and the liner 3 includes a step of curing or polymerizing the composite shell 4.

Advantageously, the step of fabricating the composite shell 4 over the boss assembly 1 and the liner 3 is preceded by a step of injecting a processing gas within the liner 3.

The invention further concerns also a vehicle comprising the pressure vessel 2.

The invention finally concerns a mandrel (not shown) for a filament-winding machine. The mandrel has means to accommodate a boss part 1b of the boss assembly 1.

In one embodiment, the means to accommodate a boss part 1b of a boss assembly 1 comprises fastening means for fastening the boss part 1b to the mandrel. The fastening means is selected from the group consisting of at least one of screwing means, mechanical interlocking means, quick connect means and the like.

In another preferred embodiment, the mandrel further comprises a thermal conditioning system (not shown) to increase the dimensional stability of the dome reinforcement part shape during the dome reinforcement part fabrication.

As illustrated in FIG. 9, the non-circular cross-sectional shape 7a is selected from the group consisting of polygonal, elliptical and truncated-circular cross-sectional shape.

As illustrated in FIG. 10, the securing means comprises three screws 5 or pins 6 fixed to the outer surface 12b of the flange part 12. The three screws 5 or pins 6 are disposed approximately equidistant from the longitudinal axis X.

### LIST OF REFERENCES

1: boss assembly
1a: dome reinforcement part
1b: boss part
2: pressure vessel
3: liner
3a: dome portion of the liner
3b: cylindrical portion of the liner
4: composite shell
5: screw
6: pin
7: cylindrical surface portion of non-circular cross-sectional shape
7a: non-circular cross-sectional shape
8: axial abutment portion
8a: groove
8b: winglet
8c: pin
9: valve system
10: polar boss
11: neck part
11a: outer surface of the neck part
11b: one axial end of the neck part
12: flange part
12a: inner surface of the flange part
12b: outer surface of the flange part

1. A boss assembly configured for a pressure vessel having a liner defining a fluid storage chamber and a composite shell enclosing or encasing the liner, the boss assembly comprising:
a dome reinforcement part comprising fiber-reinforced composite material coupled to a boss part,
wherein the dome reinforcement part is configured to be covered by the composite shell and configured to cover a dome portion of the liner,
wherein the dome reinforcement part is mechanically coupled to the boss part during the dome reinforcement part fabrication, and
wherein the dome reinforcement part is fixedly coupled to the boss part by securing element comprising an axial abutment portion, arranged on the boss part, configured for blocking axial movement of the dome reinforcement part relative to the boss part.

2. The boss assembly of claim 1, wherein the dome reinforcement part is fabricated using winding, wrapping, braiding, and/or tape placement techniques, and
wherein the boss part is suitable for use as a part of a mandrel for fabricating the dome reinforcement part.

3. The boss assembly of claim 2, wherein the dome reinforcement part is fabricated using a winding technique and the boss part is suitable for use part is used as a winding part of a mandrel for fabricating the dome reinforcement part.

4. The boss assembly of claim 1, wherein the boss part is a polar part comprising a neck part comprising an axial cylindrical hollow portion providing a fluid communication port, one axial end of the neck part being configured to provide a first coupling surface suitable for coupling the boss part to the liner.

5. The boss assembly of claim 4, wherein the polar boss further comprises a flange part extending radially outwardly from the neck part,
wherein the flange part has an inner surface and an outer surface,
wherein the inner surface of the flange part is configured to provide a second coupling surface suitable for coupling the boss part to the liner, and
wherein the outer surface of the flange part provides a third coupling surface for coupling the dome reinforcement part to the boss part during the dome reinforcement part fabrication.

6. The boss assembly of claim 1, wherein the boss part is a blind boss comprising a neck part.

7. The boss assembly of claim 5, wherein the securing element comprises a screw or pin fixed to the outer surface of the flange part, and
wherein the screw or pin is configured to penetrate the dome reinforcement part so as to block radial, axial, and rotational movements of the dome reinforcement part relative to the boss part.

8. The boss assembly of 4, wherein the securing element comprises a cylindrical surface portion of non-circular cross-sectional shape arranged on an outer surface of the neck part of the boss part,
wherein the cylindrical surface portion of non-circular cross-sectional shape is enclosed or encased by the dome reinforcement part so as to block radial and rotational movements of the dome reinforcement part relative to the boss part, and
wherein the axial abutment portion of the securing means element is arranged on the neck part of the boss part so as to block axial movement of the dome reinforcement part relative to the boss part.

9. The boss assembly of claim 8, wherein the non-circular cross-sectional shape is polygonal, elliptical, or truncated-circular cross-sectional shape, and
wherein the axial abutment portion is a groove, winglet, and/or pin.

10. A pressure vessel comprising:
a liner defining a fluid storage chamber;
a composite shell enclosing or encasing the liner; and
the boss assembly of claim 1,
wherein the dome reinforcement part is covered by the composite shell and covers a dome portion of the liner.

11. A vehicle, comprising:
the pressure vessel of claim 10.

12. A method of manufacturing a boss assembly suitable for a pressure vessel, the boss assembly having a dome reinforcement part and a boss part, the method comprising:
positioning the boss part on a dome-shaped portion of a mandrel having the dome-shaped portion;
placing the mandrel comprising the boss part in a filament-winding machine; and
fabricating the dome reinforcement part by winding layers of reinforcing fibers on the dome-shaped portion of the mandrel and the boss part and fixedly coupling the dome reinforcement part to the boss part with a securing element comprising an axial abutment portion, arranged on the boss part, configured for blocking axial movement of the dome reinforcement part relative to the boss part so as to mechanically couple the dome reinforcement part to the boss part.

13. The method of claim 12, wherein the fabricating of the dome reinforcement comprises winding reinforcing fibers on a fixedly coupling portion of the boss part so as to fixedly couple the dome reinforcement part to the boss part.

14. The method of claim 12, wherein the reinforcing fibers are impregnated with a liquid matrix, and
wherein the method further comprises:
curing or polymerizing the liquid matrix; and
removing the boss assembly from the mandrel.

15. The method of claim 14, wherein the step of curing or polymerizing the liquid matrix is a step of fully curing or fully polymerizing the liquid matrix.

16. The method of claim 12, wherein the reinforcing fibers are dry reinforcing fibers, and
wherein the method further comprises:
placing the mandrel comprising the dome reinforcement part and the boss part in a mold;
performing a resin infusion or resin transfer molding process;
removing the mandrel comprising the dome reinforcement part and the boss part from the mold; and
removing the boss assembly from the mandrel.

17. The method of claim 14, wherein the removing the boss assembly from the mandrel comprises circumferentially cutting the dome reinforcement part.

18. A method of manufacturing a pair of boss assemblies suitable for a pressure vessel, each boss assembly of the pair having a dome reinforcement part and a boss part, the method comprising
positioning each boss part of the pair of boss assemblies on each dome-shaped portion of a mandrel having two symmetrical dome-shaped portions;
placing the mandrel comprising the pair of boss parts in a filament-winding machine;
fabricating each dome reinforcement part of the pair of boss assemblies by winding layers of reinforcing fibers on each symmetrical dome-shaped portion of the mandrel and each boss part of the pair of boss assemblies and fixedly coupling each dome reinforcement part to each boss part with a securing element comprising an axial abutment portion, arranged on each boss part, configured for blocking axial movement of the dome reinforcement parts relative to the boss parts so as to mechanically couple the pair of dome reinforcement parts to the pair of boss parts.

19. The method of claim 18, wherein the fabricating of each dome reinforcement part of the pair of boss assemblies comprises winding reinforcing fibers on a fixedly coupling portion of each boss part so as to fixedly couple the pair of dome reinforcement parts to the pair of boss parts.

20. The method of claim 18, wherein the reinforcing fibers are impregnated with a liquid matrix, and
wherein the method further comprises:
curing or polymerizing the liquid matrix; and
removing the pair of boss assemblies from the mandrel.

21. The method of claim 20, wherein the curing or polymerizing of the liquid matrix comprises fully curing or fully polymerizing the liquid matrix.

22. The method of claim 18, wherein the reinforcing fibers are dry reinforcing fibers, and
wherein the method further comprises:
placing the mandrel comprising the pair of dome reinforcement parts and the pair of boss parts in a mold;
performing a resin infusion or resin transfer molding process;
removing the mandrel comprising the pair of dome reinforcement parts and the pair of boss parts from the mold; and
removing the pair of boss assemblies from the mandrel.

23. The method of claim 20, wherein the removing of the pair of boss assemblies from the mandrel comprises circumferentially cutting the pair dome reinforcement parts into two separate parts.

24. The method of claim 12, further comprising:
positioning the boss assembly onto a dome portion of a liner;
fabricating a composite shell over the boss assembly and the liner.

25. The method of claim 24, wherein the fabricating of the composite shell over the boss assembly and the liner comprises curing or polymerizing the composite shell.

26. The method of claim 24, wherein the fabricating of the composite shell over the boss assembly and the liner is preceded by a injecting a processing gas within the liner.
